(19) United States
(12) Patent Application Publication
(10) Pub. No.: US 2020/0265000 A1
(43) Pub. Date: Aug. 20, 2020

(54) INFORMATION PROCESSING SYSTEM

(71) Applicant: FUJITSU CLIENT COMPUTING LIMITED, Kanagawa (JP)

(72) Inventor: Masaharu Nagata, Kawasaki (JP)

(73) Assignee: FUJITSU CLIENT COMPUTING LIMITED, Kanagawa (JP)

(21) Appl. No.: 16/793,241

(22) Filed: Feb. 18, 2020

(30) Foreign Application Priority Data
Feb. 19, 2019 (JP) 2019-027804
Jan. 22, 2020 (JP) 2020-008679

(51) Int. Cl. G06F 13/40; G06F 13/26

(52) U.S. Cl. CPC G06F 13/4045; G06F 13/26

(57) ABSTRACT

An information processing system according to one embodiment includes platforms and a relay device including an expansion bus that connects between the platforms. Each platform includes a memory that stores transmit data to another platform through transactions occurring in the platform concerned; a controller that reads first transmit data from the memory, and transmits the first transmit data to the another platform through a first transaction among the transactions via the expansion bus; determines whether a second transaction higher in priority than the first transaction is occurring in the platform after completion of transmission of each packet of the first transmit data; and in response to the second transaction, reads second transmit data from the memory, transmits the second transmit data to the another platform through the second transaction via the expansion bus, and interrupts transmission of the first transmit data until completion of transmission of the second transmit data.

### CROSS-REFERENCE TO RELATED APPLICATIONS

This application is based upon and claims the benefit of priority from Japanese Patent Application No. 2019-027804, filed Feb. 19, 2019 and No. 2020-008679, filed Jan. 22, 2020, the entire contents of which are incorporated herein by reference.

### FIELD

Embodiments described herein relate generally to an information processing system.

### BACKGROUND

Information processing systems are known, which include a plurality of platforms and a relay device including an expansion bus, compliant with a communication protocol such as a PCIe protocol, connected to the platforms.

In such an information processing system, platforms perform PCIe operation for exchanging transmit data therebetween via an expansion bus under a communication protocol such as PCIe protocol. In this case the platforms transmit and receive transmit data in units of transaction under the communication protocol. Such a communication protocol, however, includes no concept of interrupting transmission and reception of typical transmit data to prioritize transmission and reception of urgent transmit data associated with various kinds of check and control.

Thus, history information of transactions is to be acquired through another transaction after normal completion of one transaction. It is difficult for the PCIe operation, due to its property, to implement interrupt communication used for improving communication quality of Ethernet (registered trademark), for example. Because of this, there is a limitation to the functions of Internet Protocol over Infiniband (IPoIB) or Internet Protocol over fiber channel (IPoFC), which are influenced by the PCIe operation. IPoIB refers to a serial communication procedure with an Internet Protocol (IP) protocol of TCP/IP compliant with a communication protocol as Infiniband. IPoIB is fiber (optical) communication, enabling high-speed serial communication. IPoFC includes a communication protocol as fiber Channel in place of IB part of IPoIB. As with IPoIB, IPoFC is fiber (optical) communication, enabling high-speed serial communication.

To transmit and receive urgent transmit data in the middle of transmission or reception of typical transmit data, communication channels are provided for transmitting and receiving urgent transmit data, using virtual channels of the communication protocol aside from communication channels for transmitting and receiving typical transmit data. However, such a method requires special and expensive hardware and driver for implementing virtual channels.

Thus, it is difficult to interrupt a transaction being executed by another transaction such as monitoring. This may result in the situation that the information processing system cannot be normally powered off, and cannot be normally operated upon rebooting, for example.

### SUMMARY

According to one embodiment, an information processing system includes a plurality of platforms, and a relay device including an expansion bus that connects between the platforms. The platforms each includes a memory that stores transmit data to be transmitted to another platform through transactions occurring in the platform concerned; and a controller that reads, from the memory, first transmit data to be transmitted to the another platform, and transmits the first transmit data to the another platform through a first transaction among the transactions via the expansion bus; determines whether a second transaction is occurring in the platform after completion of transmission of each of packets included in the first transmit data, the second transaction being higher in priority than the first transaction; and in response to occurrence of the second transaction, reads, from the memory, second transmit data to be transmitted to the another platform, transmits the second transmit data to the another platform through the second transaction via the expansion bus, and interrupts transmission of the first transmit data until completion of transmission of the second transmit data.

### BRIEF DESCRIPTION OF THE DRAWINGS

FIG. 1 is a diagram illustrating an exemplary overall configuration of an information processing system 1 according to a first embodiment;

FIG. 2 is a diagram illustrating an exemplary hardware configuration of the information processing system 1 according to the first embodiment;

FIG. 3 is a diagram illustrating an exemplary software configuration of platforms 2-1 to 2-3 according to the first embodiment;

FIG. 4 is a diagram illustrating an example of communication processing between processors 21-1 and 21-2 of the respective platforms 2-1 and 2-2 according to the first embodiment;

FIG. 5 is a diagram illustrating how a processor 21-8 of a platform 2-8 appears from the processor 21-1 of the platform 2-1;

FIG. 6 is a diagram illustrating how the processor 21-8 of the platform 2-8 appears from the processor 21-1 of the platform 2-1;

FIG. 7 is a diagram illustrating an exemplary data transfer method between platforms 2-1 and 2-5 via a relay device 3 in the first embodiment;

FIG. 8 is a block diagram illustrating an example of transmission of transmit data by the platform 2-1 in the information processing system 1 of the first embodiment;

FIG. 9 is a flowchart illustrating an exemplary procedure of transmitting transmit data by the platform 2 in the information processing system 1 of the first embodiment;

FIG. 10 is a diagram illustrating an exemplary detailed block configuration of software of platforms 2-1 to 2-3 according to a second embodiment;

FIG. 11 is a sequence diagram illustrating each element's procedure when an information processing system 1 transmits transmit data in the second embodiment;

FIG. 12 is a diagram illustrating an exemplary hardware configuration of an information processing system 1200 according to a third embodiment; and

FIG. 13 is a block diagram illustrating an exemplary procedure of transmitting transmit data by the platform 2-1 in the information processing system 1200 according to the third embodiment.

### DETAILED DESCRIPTION

The following will describe embodiments of an information processing system with reference to the accompanying drawings.

### First Embodiment

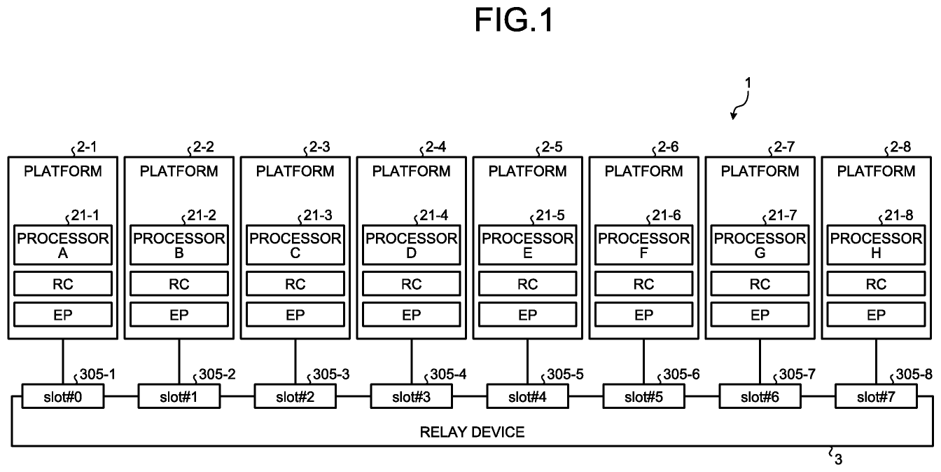

FIG. 1 is a diagram illustrating an exemplary overall configuration of an information processing system 1 according to a first embodiment. As illustrated in FIG. 1, the information processing system 1 according to the present embodiment includes a plurality of platforms 2-1 to 2-8 and a relay device 3. The platforms 2-1 to 2-8 are connected to the relay device 3.

In the following, any of the platforms are referred to as a platform 2 unless the platforms 2-1 to 2-8 are to be mutually distinguished. Herein, the information processing system 1 includes eight platforms 2-1 to 2-8 by way of example. The number of platforms is not limited thereto so long as the information processing system 1 includes two or more platforms 2.

Each of the platforms 2-1 to 2-8 serves as a host personal computer (PC) that functions as a control unit and a graphical user interface (GUI) of the information processing system 1, or a calculator that performs artificial intelligence (AI) inference processing and image processing, for example.

Specifically, the platforms 2-1 to 2-8 include processors 21-1 to 21-8, respectively. In the following, any of the processors 21-1 to 21-8 are referred to as a processor 21 unless the platforms 2-1 to 2-8 are to be mutually distinguished. The processors 21-1 to 21-8 may be provided by different manufacturers or vendors, or by the same manufacturer.

For example, it is assumed that the processors 21-1, 21-2, 21-3, 21-4, 21-5, 21-6, 21-7, and 21-8 be provided by A company, B company, C company, D company, E company, F company, G company, and H company, respectively.

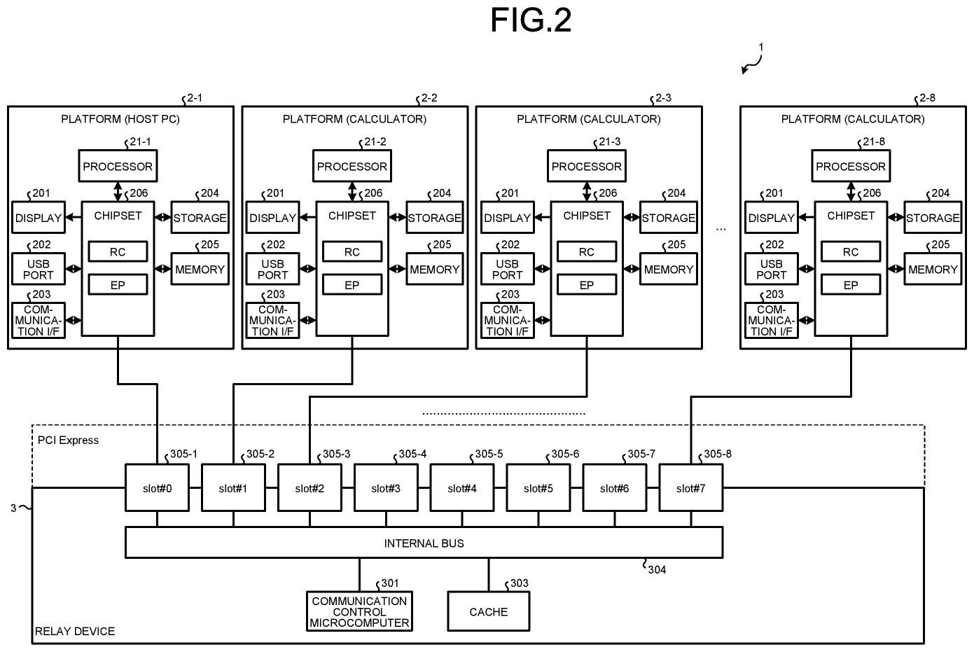

Different platforms 2 may be connected to respective slots 305-1 to 305-8 incorporated in the relay device 3, or one platform 2 may be connected to each of the slots 305-1 to 305-8 and the platform 2 may communicate with the relay device 3 using a plurality of root complexes (RCs). RCs serve as controllers that manage devices in the environment compliant with the PCIe protocol. The RCs are device managers, therefore, they are typically one bus system and only one RC. However, in the environment that multiple micro processing units (MPUs) connected via a plurality of buses appear to be one information processing device, a plurality of RCs may be included. A system including a plurality of RCs is often used for a workstation, for example, and referred to as non-uniform memory access (NUMA). The platform 2 includes the RC and an end point (EP) and communicates with the relay device 3 via the RC and the EP. In the present embodiment, the platform 2 includes the RC and the EP in a chipset 206 (refer to FIG. 2) described later. The EP serves as a controller that passively processes data in response to an instruction from the RC in the environment compliant with the PCIe protocol.

The following describes an exemplary hardware configuration of the information processing system 1 of the present embodiment, referring to FIG. 2. FIG. 2 is a diagram illustrating an exemplary hardware configuration of the information processing system 1 of the present embodiment. The following describes an example that the platform 2-1 functions as a host PC, and the platforms 2-2 to 2-8 function as calculators that perform AI inference processing or image processing.

First, the following describes a hardware configuration of the platform 2-1 functioning as the host PC. Herein, the hardware configuration of the platform 2-1 is described. The platforms 2-2 to 2-8 that function as the calculators have the same hardware configuration as the platform 2-1.

As illustrated in FIG. 2, the platform 2-1 includes the processor 21-1, a display 201, a universal serial bus (USB) port 202, a communication interface (I/F) 203, a storage 204, a memory 205, and the chipset 206.

The display 201 represents a liquid crystal display (LCD) and displays various kinds of information. The USB port 202 serves as a connector for connecting the platform 2-1 with peripheral devices. The communication I/F 203 is communicable with a network such as a local area network (LAN) under a communication protocol such as Ethernet (registered trademark).

The storage 204 is a storage device such as a hard disk drive (HDD), a solid state drive (SSD), and a storage class memory (SCM), and stores various kinds of data. The memory 205 represents a read only memory (ROM) or a random access memory (RAM). The ROM stores various software programs and data for use in the software programs. The software programs stored in the ROM is read and executed by the processor 21-1. The RAM functions as a work area in executing the software programs stored in the ROM.

The processor 21-1 represents a central processing unit (CPU), a micro processing unit (MPU), a digital signal processor (DSP), an application specific integrated circuit (ASIC), a programmable logic device (PLD), or a field programmable gate array (FPGA), and controls the entire platform 2-1. The processor 21-1 may be a multicore processor or a combination of two or more processors.

The processor 21-1, the USB port 202, the communication I/F 203, the storage 204, and the memory 205 are mutually connected in the chipset 206. In the present embodiment, the chipset 206 includes the RC and the EP for connecting to the relay device 3.

Next, a hardware configuration of the relay device 3 is described.

For example, as illustrated in FIG. 2, the relay device 3 includes the slots 305-1 to 305-8. Specifically, the relay device 3 includes a communication control microcomputer 301, a cache 303, and the slots 305-1 to 305-8 as illustrated in FIG. 2. As illustrated in FIG. 2, the communication control microcomputer 301, the cache 303, and the slots 305-1 to 305-8 are connected to one another in a communicable manner via an internal bus 304.

Each of the slots 305-1 to 305-8 is an exemplary expansion bus and to be connected to a device that satisfies a communication protocol such as the PCIe protocol. In the present embodiment, the platforms 2-1 to 2-8 are connected to the slots 305-1 to 305-8, respectively. In the following any of the slots 305-1 to 305-8 is referred to as a slot 305 unless the slots are to be mutually distinguished.

One platform 2 may be connected to one slot 305, or a plurality of platforms 2 may be connected to one slot 305. Further, the platform 2 having two or more slots 305 allocated is communicable in a broader communication band.

The cache 303 works as a mechanism that temporarily stores transmit data to be transmitted to devices having different performance, in order to reduce a difference in performance.

The platform 2 is provided with slot storage regions (described later) on the memory 205 corresponding to the slots 305. The relay device 3 transfers transmit data between the platforms 2 on the basis of address information on the slot storage regions corresponding to the slots 305 on the memory 205 of the platform 2.

The communication control microcomputer 301 includes a processor such as a CPU, an MPU, a DSP, an ASIC, a PLD, or an FPGA, and the processor transfers the transmit data between the platforms 2 via the slot 305. The communication control microcomputer 301 may include a combination of two or more processors. By executing a software program stored in a storage (not illustrated) of the relay device 3, the communication control microcomputer 301 transfers the transmit data between the platforms 2 connected to the slots 305.

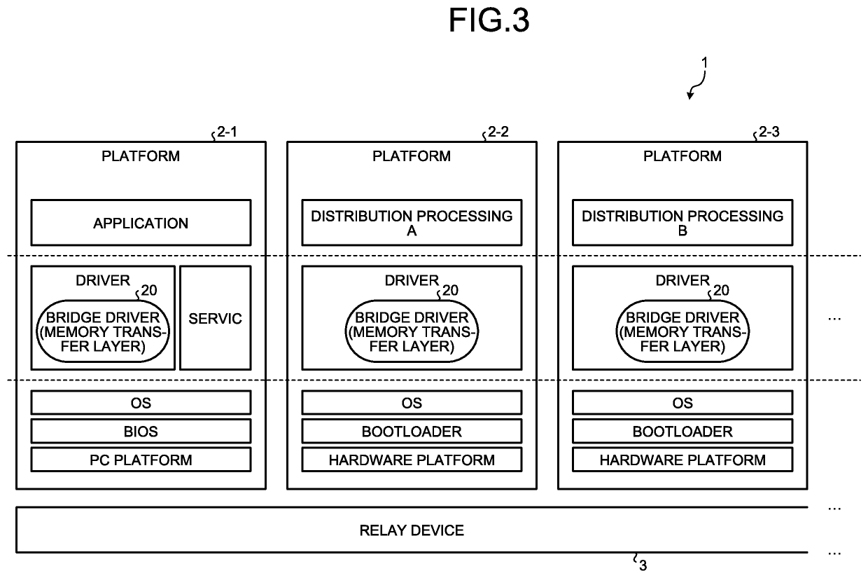

Next, the following describes an exemplary software configuration of the platforms 2-1 to 2-3 according to the present embodiment with reference to FIG. 3. FIG. 3 is a diagram illustrating an exemplary software configuration of the platforms 2-1 to 2-3 according to the present embodiment. Although not illustrated in FIG. 3, the platforms 2-4 to 2-8 have the same software configuration as the platforms 2-2 and 2-3.

For example, the platform 2-1 includes Windows (registered trademark) as an operating system (OS), and executes various software programs on the OS. The platforms 2-2 and 2-3 include Linux (registered trademark) as an OS, for example, and execute various software programs on the OS.

Each of the platforms 2-1 to 2-3 includes a bridge driver 20 and communicates with another platform 2 via the bridge driver 20. Each of the platforms 2-1 to 2-3 includes the processor 21 and the memory 205. The processor 21 executes the OS, various computer programs, and a driver stored in the memory 205 to implement various functions of the platform 2.

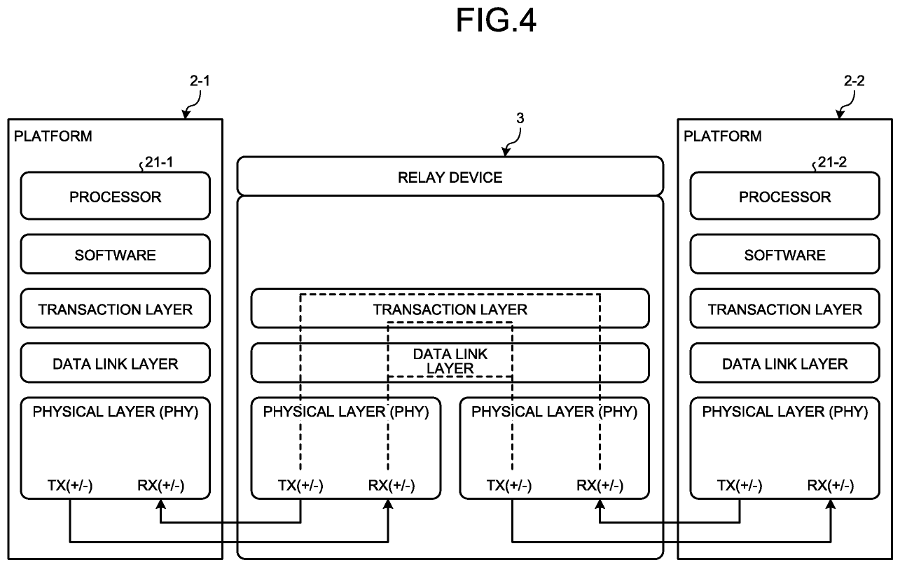

Next, the following describes an example of communication processing between the platforms 2-1 and 2-2 connected to the relay device 3 with reference to FIG. 4. FIG. 4 is a diagram illustrating an example of communication processing between the processors 21-1 and 21-2 of the respective platforms 2-1 and 2-2 according to the present embodiment. Herein, communication processing between the processor 21-1 of the platform 2-1 and the processor 21-2 of the platform 2-2 is described as an example.

Data generated by the processor 21-1 of the platform 2-1 as a transmission source is successively transferred through software, a transaction layer, a data link layer, and a physical layer (PHY), and is transferred from the physical layer to a physical layer of the relay device 3.

In the relay device 3, the data transferred from the processor 21-1 as a transmission source is successively transferred through the physical layer, the data link layer, and the transaction layer, and is transferred to the EP corresponding to the processor 21-2 as a transmission destination by tunneling. That is, in the relay device 3, the data is transferred from one processor 21-1 to another processor 21-2 by tunneling the data between the EPs.

The data is transferred from the relay device 3 to the processor 21-2 as a transmission destination and successively transferred through the physical layer (PHY), the data link layer, the transaction layer, and the software, and is transferred to the processor 21-3 as a transmission destination. In the information processing system 1 of the present embodiment, communication between the processors 21 is logically implemented in response to occurrence of a PCIe transaction.

Unless data transfer from the processors 21 concentrates on the processor 21 connected to one of the slots 305 of the relay device 3, any different sets of processors 21 can transfer data in parallel. For example, when the processor 21-2 and the processor 21-3 are both to communication with the processor 21-1, the relay device 3 serially processes the communications by the processor 21-2 and the processor 21-3.

While the processors 21 of different platforms 2 communicate with each other, the relay device 3 can process the communication between the platforms 2 in parallel unless communication concentrates on the processor 21 of a specific platform 2.

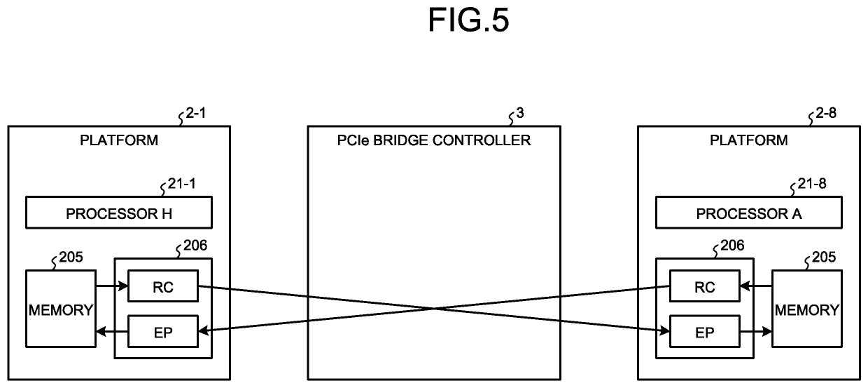

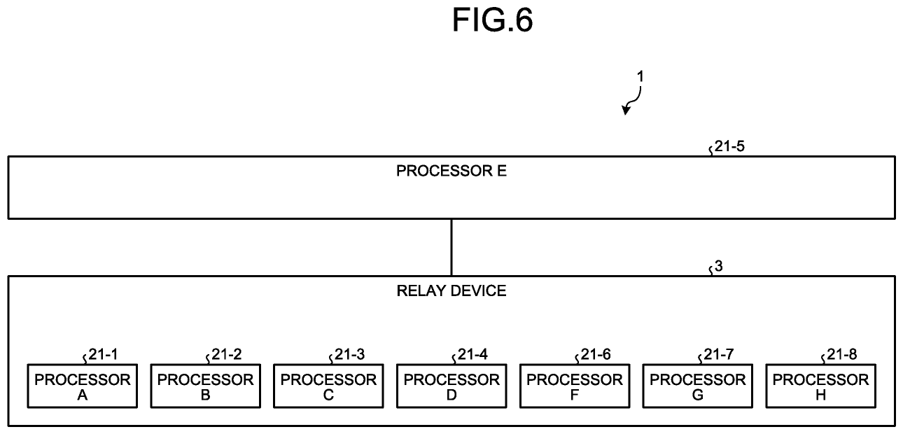

Next, how the processor 21-8 of the platform 2-8 appears from the processor 21-1 of the platform 2-1 is described with reference to FIG. 5 and FIG. 6. FIG. 5 and FIG. 6 are diagrams illustrating how the processor 21-8 of the platform 2-8 appears from the processor 21-1 of the platform 2-1.

While the processors 21-1 and 21-8 of the respective platforms 2-1 and 2-8 communicate with each other, the OS (for example, a device manager of Windows (registered trademark)) executed by each of the processors 21-1 and 21-8 can see the relay device 3 alone, therefore, the OS does not directly manage the processor 21-8 of the platform 2-8 as a connection destination. That is, the device driver of the relay device 3 manages the processor 21-8 of the platform 2-8 connected earlier to the relay device 3.

This eliminates the necessity for preparing a special device driver that operates the processors 21-1 and 21-8 of the platforms 2-1 and 2-8 as a transmission source and a transmission destination. The device driver of the relay device 3 communicates with the relay device 3 alone, thereby implementing communication between the platforms 2-1 and 2-8.

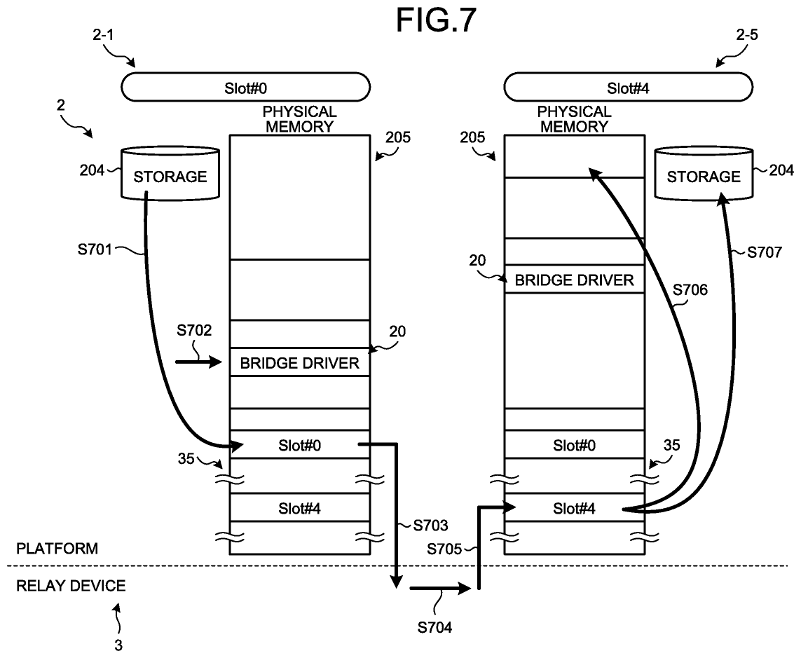

Next, a data transfer method between the platforms 2-1 and 2-5 via the relay device 3 is described with reference to FIG. 7. FIG. 7 is a diagram illustrating an exemplary data transfer method between the platforms 2-1 and 2-5 via the relay device 3 according to the present embodiment.

In the example illustrated in FIG. 7, data is transferred from the platform 2-1 connected to the slot #0 to the platform 2-5 connected to the slot #4.

The platform 2-1 as a transmission source stores transmit data transmitted by software in the storage 204 35 and transfers it to a memory region of the memory 205 for storage (Step S701). The memory region 35 may be part of a communication buffer that temporarily stores data to be transferred. The memory region 35 includes slot storage regions divided in accordance with the number of the slots 305. Each divided slot storage regions of the memory region 35 is associated with any of the slots 305. For example, the slot storage region Slot #0 in the memory region 35 is associated with the platform 2-1 connected to Slot #0. The slot storage region Slot #4 in the memory region 35 is associated with the platform 2-5 connected to Slot #4. The platform 2-1 stores the transmit data in the slot storage region allocated to the slot 305-1 of the platform 2-1 (herein, Slot #0) among the slot storage regions of the memory region 35.

The bridge driver 20 of the platform 2-1 acquires or generates slot information indicating the slot 305 being a transmission destination, and address information indicating an address in the slot storage region of the memory region 35 as a transmission destination (Step S702).

Subsequently, the bridge driver 20 of the platform 2-1 sends, to the relay device 3, transfer data including the slot information, the address information, and the transmit data (Step S703). Thereby, the relay device 3 connects the slot 305-1 being a transmission source with the slot 305-5 being a transmission destination according to the slot information, to transfer the transfer data to the platform 2-5 being a transmission destination (Step S704). The bridge driver 20 of the transmission destination stores the transmit data or the transfer data in one of the divided slot storage regions of the memory region 35 in the memory 205 corresponding to the slot 305-5 (Slot #4) of the platform 2 on the basis of the slot information and the address information (Step S705).

In the platform 2-5 being a transmission destination, for example, a computer program serves to read the transmit data from the memory region 35 of the memory 205, and transfers the transmit data to the memory (local memory) 205 or the storage 204 (Steps S706 and S707).

As described above, the data (transfer data) is transferred from the platform 2-1 being a transmission source to the platform 2-5 being a transmission destination.

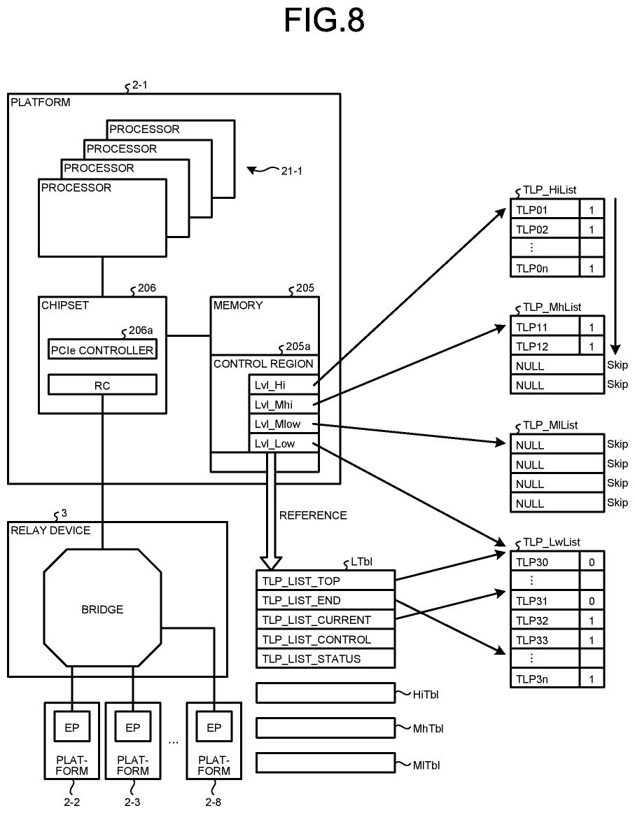

Next, the following describes characteristic transmission processing of transmit data by the platform 2-1 in the information processing system 1 according to the present embodiment, with reference to FIG. 8. FIG. 8 is a block diagram illustrating an example that the platform 2-1 of the information processing system 1 transmits transmit data in the present embodiment. Herein, the platform 2-1 transmits transmit data of a PCIe transaction to another platform 2. The platforms 2 other than the platform 2-1 transmit the transmit data of a PCIe transaction to another platform 2 in the same manner.

The processor 21-1 generates transmit data to be transferred to another platform 2 for PCIe transaction.

The memory 205 includes storage regions for storing a transaction layer packet (TLP, an exemplary packet) or a data link layer packet (DLLP, an exemplary packet) contained in the transmit data, which is generated by the processor 21-1 for each transaction. Each storage region contains the address information of the storage region. Exchange of the transmit data between the platforms 2 via a PCIe bus is managed as a transaction. The transmit data in units of transaction includes two or more TLPs or DLLPs. TLPs are used in exchanging transmit data between the platforms 2. The transmit data may not reach a transmission destination because of hardware error, for example, in the process of exchanging the transmit data via the PCIe bus. In such a case, the platforms 2 exchange transmit data including DLLPs as frames dedicated to information exchange control, for requesting transmit data as a control frame again, for example. The following describes transmit data containing TLPs as an example. However, transmit data containing DLLPs can be handled in the same manner.

In the present embodiment, as illustrated in FIG. 8, the memory 205 (herein, slot storage regions) includes a control region 205a serving as a set of request tables (for example, four request tables TLP HiList, TLP_MhList, TLP MlList, and TLP_LwList) each including a storage region that stores TLPs or DLLPs of transactions with priority.

Herein, priority refers to priority of processing PCIe transactions. In the present embodiment, the priority includes a priority Lvl_Hi, a priority Lvl_Mhi, a priority Lvl_Mlow, and a priority Lvl_Low. Specifically, the priority Lvl_Hi is the highest priority, the priority Lvl_Mhi is the second highest priority after the priority Lvl_Hi, the priority Lvl_Mlow is the third highest priority after the priority Lvl_Mhi, and the priority Lvl_Low is the lowest

### PRIORITY

The priority Lvl_Low is, for example, of typical transactions such as transmitting image data. The priority Lvl_Hi is, for example, of transactions such as transaction progress check, interruption of a transaction, and a power-on/off operation to the information processing system 1. The priorities Lvl_Mhi and Lvl_Mlow are of transactions other than typical transactions and the transactions as transaction progress check, interruption of a transaction, and a power-on/off operation to the information processing system 1.

The present embodiment describes an example of setting any of the four priorities Lvl_Hi, Lvl_Mhi, Lvl_Mlow, and Lvl_Low to the PCIe transactions. However, the present embodiment is not limited thereto so long as one of two or more priorities is set to the PCIe transactions. For example, one of two priorities may be set to a PCIe transaction, or any of five or more priorities may be set to a PCIe transaction.

In the present embodiment, the storage region of the request table containing TLPs stores the address information of the storage region on the memory region 35 (memory 205) of the platform 2-1. The address information contained in the request table includes a bit indicating completion or non-completion of transmission of a TLP. Hereinafter, such a bit referred to as a transfer completed bit, as an example of transfer completion information. For example, unit digit of the address information is set to the transfer completed bit. The transfer completed bit indicates zero after completion of transmission of a TLP, and indicates one before completion of the transmission of a TLP.

The chipset 206 includes a PCIe controller 206a (an exemplary controller). The PCIe controller 206a is implemented by the bridge driver 20 (refer to FIG. 2, for example). In the present embodiment, the PCIe controller 206a performs DMA transfer of transmit data between the platforms 2.

Specifically, the PCIe controller 206a reads, from the memory 205, transmit data to be transmitted to another platform 2 through a first transaction among PCIe transactions occurring in the platform 2-1 (hereinafter, referred to as first transmit data), and transmits the first transmit data to another platform 2 via the slot 305-1. The PCIe controller 206a determines whether a PCIe transaction having a higher priority than the first transaction (hereinafter, referred to as a second transaction) is occurring in the platform 2-1, upon completion of the transmission of each TLP of the first transmit data.

In response to occurrence of the second transaction, the PCIe controller 206a reads, from the memory 205, transmit data (hereinafter, referred to as second transmit data) to be transmitted to another platform 2 through the second transaction, and transmits the second transmit data to another platform 2 via the slot 305-1. The PCIe controller 206a suspends transmission of the first transmit data to another platform 2 until the second transmit data is transmitted to another platform 2.

Thereby, the PCIe controller 206a can interrupt the transmission of the first transmit data of the first transaction to transmit the second transmit data of the second transaction having a higher priority. As a result, the PCIe controller 206a can execute the second transaction having a higher priority, such as transaction progress check, interruption of a transaction, and a power-on/off operation to the information processing system 1, without waiting for completion of the first transaction. In the end, the PCIe controller 206a can synchronize the processes among the processors 21 of the platforms 2, and turn off the power of the information processing system 1 in a stable state.

Specifically, to transmit the transmit data to another platform 2, the PCIe controller 206a reads a TLP from the request table and transmit it to another platform 2. The PCIe controller 206a reads a TLP with the transfer completed bit of 1, which is included in the address information stored in the TLP storage region, among the TLPs stored in the storage region of the request table, and transmits the TLP to another platform 2. That is, the PCIe controller 206a transmits, to another platform 2, the TLP with the transfer completed bit of the address information indicating non-completion of transmission, among the TLPs stored in the memory 205. After transmitting the TLP to another platform 2, the PCIe controller 206a updates, to 0, the transfer completed bit of the address information stored in the storage region of the TLP transmitted to another platform 2. Thereby, the PCIe controller 206a can recognize completion or non-completion of transmission of the TLP to another platform 2, therefore, can avoid transmitting the transmitted TLP to another platform 2 again.

The PCIe controller 206a acquires or generates level tables (for example, level tables HiTbl, MhTbl, MlwTbl, and LwTbl) for the respective priorities of the transactions. The PCIe controller 206a then writes the acquired or generated level tables to the memory 5. As illustrated in FIG. 8, the level tables each include current information (TLP_LIST_CURRENT). The current information represents the address information of the storage region on the memory 205, the storage region storing a next TLP to transmit or a TLP being transmitted among the TLPs of the transmit data. In the present embodiment, the level table includes TLP_LIST_TOP, TLP_LIST_END, TLP_LIST_CONTROL, and TLP_LIST STATUS in addition to the current information (TLP_LIST_CURRENT), as illustrated in FIG. 8.

TLP_LIST_TOP includes address information of a head storage region (head address information) containing a TLP to be initially transmitted among the TLPs of the transmit data. TLP_LIST_END includes address information of an end storage region (end address information) containing a TLP to be lastly transmitted among the TLPs of the transmit data. TLP_LIST_CONTROL serves as a memory management control flag indicating a snoop method of the storage region storing the transmit data. Snooping is now described. In the case of using the memory 205 via a cache, the transmit data stored in the cache inside the processor 21 such as an MPU may temporarily diverge from the transmit data stored in the memory 205 or a device control register. Snooping refers to arrangement for transmitting and receiving transmit data between devices while physically adjusting the transmit data along with progress. There are various snooping methods such as manually updating data to the latest or updating data to the latest in accordance with access time. TLP_LIST_CONTROL serves as a memory management control flag indicating such snooping method. TLP_LIST STATUS includes status information indicating whether error occurs in transmission of transmit data. This makes it possible to readily identify occurrence of error in transmission of the transmit data, with reference to the level tables.

In the present embodiment, in response to a transaction, the PCIe controller 206a re-sets the level table corresponding to the priority of the transaction, referring to the request table including the transaction with the priority. The PCIe controller 206a then transmits, to another platform 2, TLPs in order starting from the TLP stored in the storage region on the memory 205 indicated by TLP_LIST_TOP to the TLP stored in the storage region on the memory 205 indicated by TLP_LIST_END included in the level table for the transaction concerned, while shifting the storage regions one by one.

However, while interrupting transmission of the transmit data to another platform 2, the PCIe controller 206a transmits, to another platform 2, the TLPs in order starting from the TLP stored in the storage region on the memory 205 indicated by TLP_LIST_CURRENT to the TLP stored in the storage region on the memory 205 indicated by TLP_LIST_END included in the level table, while shifting the storage regions one by one.

Thereby, the PCIe controller 206a can determine whether error occurs in transmission of transmit data by checking the level table. As a result, the PCIe controller 206a can reduce processing load due to interrupted communication for transmitting the first transmit data of the first transaction, to transmit the second transmit data of the second transaction having a higher priority. To check a communication stop state, the platforms 2 can exchange transmit data at a higher speed by snooping since the level tables are stored on the memory 205.

In the present embodiment, the PCIe controller 206a acquires or generates a reception level table, as with the transmission level tables as described above, and writes the acquired or generated reception level table to the memory 205. At the time of receiving transmit data from another platform 2, the PCIe controller 206a writes TLPs or DLLPs of the received transmit data to the memory 205 referring to the reception level table.

In the present embodiment, the processing by the PCIe controller 206a is implemented by executing the bridge driver 20 (software). However, transmission of the TLPs of transmit data of a transaction can be implemented by hardware such as a dedicated LSI. This makes it possible to reduce overhead of the processor executing the bridge driver 20 to a minimum by increasing the speed at which transmit data is written to the request table and the level table is acquired or generated, which occurs in response to every new transaction, and the speed at which the platforms 2 communicate transmit data, for example. In this case, hardware such as a dedicated LSI continuously transmits TLPs of transmit data of transactions in descending order of the priority of the transactions.

Next, the following describes an exemplary procedure of transmitting transmit data by the platform 2-1 of the information processing system 1 according to the present embodiment, with reference to FIG. 8.

Described herein is transmission of transmit data by the platform 2-1 when transactions having the priorities Lvl_Hi and Lvl_Mhi occur during transmission of transmit data of a transaction having the priority Lvl_Low.

First, in response to a transmission/reception request for transmit data of a transaction having the priority Lvl_Low, as illustrated in FIG. 8, the PCIe controller 206a writes the transmit data into the request table TLP_LwList for the transaction having the priority Lvl_Low.

Further, as illustrated in FIG. 8, the PCIe controller 206a sets the level table LwTbl of the priority Lvl_Low again, referring to the request table TLP_LwList. Specifically, the PCIe controller 206a sets head address information of the head storage region in the request table TLP_LwList of the transaction to TLP_LIST_TOP of the level table LwTbl of the priority Lvl_Low. The PCIe controller 206a sets end address information of the end storage region in the request table TLP_LwList of the transaction to TLP_LIST_END of the level table LwTbl of the priority Lvl_Low. The PCIe controller 206a also sets, to TLP_LIST_CURRENT of the level table LwTbl of the priority Lvl_Low, address information of the storage region storing a next TLP to transmit or a TLP being transmitted among the storage regions in the request table TLP_LwList of the transaction.

Next, the PCIe controller 206a transmits, to another platform 2, the TLPs in order starting from the TLP (for example, a TLP30) stored in the storage region on the memory 205 indicated by TLP_LIST_TOP included in the level table LwTbl of the priority Lvl_Low up to the TLP (TLP3n) stored in the storage region on the memory 205 indicated by TLP_LIST_END included in the level table LwTbl, while shifting the storage regions one by one. Upon every transmission of one TLP of the transmit data of the transaction having the priority Lvl_Low, the PCIe controller 206a determines whether to have received a transmission/reception request for the transmit data of transactions having the priorities Lvl_Hi, Lvl_Mhi, and Lvl_Mlow higher than the priority Lvl_Low.

In response to the transmission/reception request for the transmit data of the transactions having the priorities Lvl_Hi and Lvl_Mhi during transmission of a TLP (for example, TLP31) of the transmit data of the transaction having the priority Lvl_Low, the PCIe controller 206a writes the transmit data to the request tables TLP HiList and TLP_MhList of the transactions having the priorities Lvl_Hi and Lvl_Mhi. Referring to the request tables TLP HiList and TLP_MhList, the PCIe controller 206a sets the level tables HiTbl and MhTbl of the priorities Lvl_Hi and Lvl_Mhi.

Subsequently, the PCIe controller 206a interrupts transmission of the TLPs of the transmit data of the transaction having the priority Lvl_Low, and transmits, to another platform 2, TLPs in order starting from a TLP (for example, TLP01) stored in the storage region on the memory 205 indicated by TLP_LIST_TOP included in the level table HiTbl of the priority Lvl_Hi up to a TLP (for example, TLP0n) stored in the storage region on the memory 205 indicated by TLP_LIST_END included in the level table HiTbl, while shifting the storage regions one by one.

Next, the PCIe controller 206a transmits, to another platform 2, TLPs in order starting from a TLP (for example, TLP11) stored in the storage region on the memory 205 indicated by TLP_LIST_TOP included in the level table MhTbl of the priority Lvl_Mhi, while shifting the storage regions one by one. Upon every transmission of one TLP of the transmit data of the transaction having the priority Lvl_Mhi, the PCIe controller 206a determines whether to have received a transmission/reception request for the transmit data of a new transaction having the priority Lvl_Hi higher than the priority Lvl_Mhi. In response to no receipt of the transmission/reception request for the transmit data of a new transaction having the priority Lvl_Hi, the PCIe controller 206a transmits, to another platform 2, the TLPs up to the TLP stored in the storage region on the memory 205 indicated by TLP_LIST_END included in the level table MhTbl of the priority Lv_Mhi.

However, in the example illustrated in FIG. 8, the storage regions following the storage region of a TLP12 in the request table TLP_MhList are NULL. Thus, the PCIe controller 206a transmits, to another platform 2, the TLPs before the TLP12 stored in the request table TLP_MhList.

After completion of the transmission of the transmit data of the transactions having the priorities Lvl_Hi and Lvl_Mhi higher than the priority Lvl_Low, the PCIe controller 206a resumes transmission of the TLPs to another platform 2 in order starting from a TLP (for example, TLP32) stored in the storage region on the memory 205 indicated by TLP_LIST_CURRENT in the level table LwTbl of the priority Lvl_Low, and transmits, to another platform 2, the TLPs up to a TLP (for example, TLP3n) stored in the storage region on the memory 205 indicated by TLP_LIST_END included in the level table LwTbl.

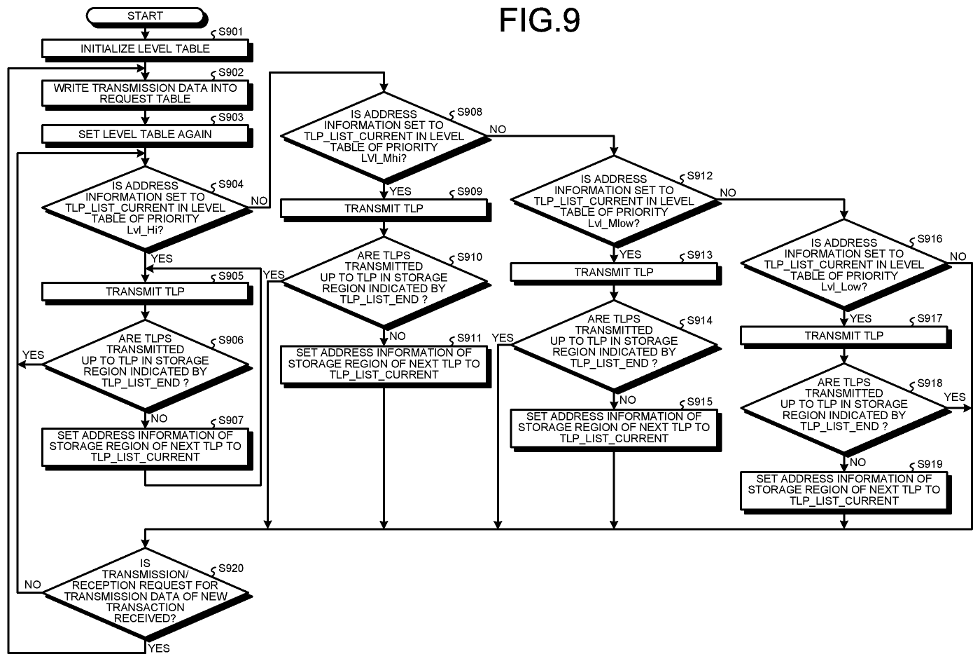

Next, the following describes an exemplary procedure of transmitting transmit data by the platform 2 in the information processing system 1 according to the present embodiment, with reference to FIG. 9. FIG. 9 is a flowchart illustrating an exemplary procedure of transmitting transmit data by the platform 2 in the information processing system 1 according to the present embodiment.

First, the PCIe controller 206a initializes the level table of each priority of a transaction (Step S901). Specifically, the PCIe controller 206a initializes the level tables by setting TLP_LIST_CURRENT, TLP_LIST_TOP, TLP_LIST_END, TLP_LIST_CONTROL, and TLP_LIST STATUS of each level table with priority to zero.

In the present embodiment, the PCIe controller 206a initializes the level tables HiTbl, MhTbl, MlwTbl, and LwTbl of the four priorities Lvl_Hi, Lvl_Mhi, Lvl_Mlow, and Lvl_Low.

Subsequently, in response to occurrence of a PCIe transaction and receipt of a transmission/reception request for the transmit data of the transaction in question, the PCIe controller 206a writes the transmit data into the request table of the transaction (Step S902). Referring to the request table, the PCIe controller 206a sets the level table of the priority of the transaction again (Step S903).

After setting the level table again, the PCIe controller 206a determines whether the address information is set to TLP_LIST_CURRENT in the level table HiTbl of the highest priority Lvl_Hi (Step S904).

After determining that the address information is set to TLP_LIST_CURRENT in the level table HiTbl of the highest priority Lvl_Hi (Yes at Step S904), the PCIe controller 206a transmits, to another platform 2, the TLPs in order starting from the TLP stored in the storage region on the memory 205 indicated by TLP_LIST_TOP included in the level table HiTbl of the priority Lvl_Hi up to the TLP stored in the storage region on the memory 205 indicated by TLP_LIST_END included in the level table HiTbl, while shifting the storage regions one by one (Step S905). Upon every completion of the transmission of one TLP to another platform 2, the PCIe controller 206a determines whether to have completed the transmission of the TLPs to another platform 2 up to the TLP stored in the storage region on the memory 205 indicated by TLP_LIST_END included in the level table HiTbl of the priority Lvl_Hi (Step S906).

After determining non-completion of the transmission of the TLPs to another platform 2 up to the TLP indicated by TLP_LIST_END included in the level table HiTbl of the priority Lvl_Hi (No at Step S906), the PCIe controller 206a sets the address information of the storage region of a next TLP to transmit among the storage regions of the request table TLP HiList to TLP_LIST_CURRENT included in the level table HiTbl of the priority Lvl_Hi (Step S907). The PCIe controller 206a also updates, to zero, the transfer completed bit of the address information of the TLP lastly transmitted among the address information in the request table TLP HiList, and returns to Step S905.

After determining completion of the transmission of the TLPs to another platform 2 up to the TLP stored in the storage region on the memory 205 indicated by TLP_LIST_END included in the level table HiTbl of the priority Lvl_Hi (Yes at Step S906), the PCIe controller 206a sets an end flag to the request table TLP HiList, and ends the transmission of the transmit data. In the present embodiment, the PCIe controller 206a updates, to zero, the transfer completed bit of the address information at the end of the request table TLP HiList, completing the transmission of the transmit data.

Thereafter, the PCIe controller 206a returns to Step S904, and determines whether the address information is set to TLP_LIST_CURRENT in the level table LwTbl of the priority Lvl_Hi again. After determining that the address information is not set to TLP_LIST_CURRENT in the level table LwTbl of the priority Lvl_Hi (No at Step S904), the PCIe controller 206a determines whether the address information is set to TLP_LIST_CURRENT in the level table MhTbl of the priority Lvl_Mhi (Step S908).

After determining that the address information is set to TLP_LIST_CURRENT in the level table MhTbl of the priority Lvl_Mhi (Yes at Step S908), the PCIe controller 206a transmits, to another platform 2, the TLPs in order starting from the TLP stored in the storage region on the memory 205 indicated by TLP_LIST_TOP included in the level table MhTbl of the priority Lvl_Mhi up to the TLP stored in the storage region on the memory 205 indicated by TLP_LIST_END included in the level table MhTbl, while shifting the storage regions one by one (Step S909). Upon every completion of the transmission of one TLP to another platform 2, the PCIe controller 206a determines whether to have transmitted the TLPs to another platform 2 up to the TLP stored in the storage region on the memory 205 indicated by TLP_LIST_END included in the level table MhTbl of the priority Lvl_Mhi (Step S910).

After determining to have not transmitted the TLPs to another platform 2 up to the TLP stored in the storage region on the memory 205 indicated by TLP_LIST_END included in the level table MhTbl of the priority Lvl_Mhi (No at Step S910), the PCIe controller 206a sets the address information of the storage region of a next TLP to transmit among the storage regions of the request table TLP_MhList to TLP_LIST_CURRENT included in the level table MhTbl of the priority Lvl_Mhi (Step S911). The PCIe controller 206a also updates, to zero, the transfer completed bit of the address information of the TLP having been lastly transmitted among the address information in the request table TLP_MhList of the transaction having the priority Lvl_Mhi. The PCIe controller 206a further determines whether to have received a transmission/reception request for the transmit data of a new transaction (Step S920). In response to no receipt of the transmission/reception request for the transmit data of a new transaction (No at Step S920), the PCIe controller 206a returns to Step S904. In response to receipt of transmission/reception request for the transmit data of a new transaction (Yes at Step S920), the PCIe controller 206a returns to Step S902.

After determining to have transmitted the TLPs to another platform 2 up to the TLP stored in the storage region on the memory 205 indicated by TLP_LIST_END included in the level table MhTbl of the priority Lvl_Mhi at Step S910 (Yes at Step S910), the PCIe controller 206a sets the end flag to the request table TLP_MhList of the transaction having the priority Lvl_Mhi, completing the transmission of the transmit data of the transaction. Then, the PCIe controller 206a proceeds to Step S920.

At Step S908, if the address information is not set to TLP_LIST_CURRENT in the level table MhTbl of the priority Lvl_Mhi (No at Step S908), the PCIe controller 206a determines whether the address information is set to TLP_LIST_CURRENT in the level table MhTbl of the priority Lvl_Mlow (Step S912).

If the address information is set to TLP_LIST_CURRENT in the level table MlTbl of the priority Lvl_Mlow (Yes at Step S912), the PCIe controller 206a transmits, to another platform 2, the TLPs in order starting from the TLP stored in the storage region on the memory 205 indicated by TLP_LIST_TOP included in the level table MlTbl of the priority Lvl_Mlow up to the TLP stored in the storage region on the memory 205 indicated by TLP_LIST_END included in the level table MlTbl, while shifting the storage regions one by one (Step S913). Upon every completion of the transmission of one TLP to another platform 2, the PCIe controller 206a determines whether to have transmitted the TLPs to another platform 2 up to the TLP stored in the storage region on the memory 205 indicated by TLP_LIST_END included in the level table MlTbl of the priority Lvl_Mlow (Step S914).

After determining to have not transmitted the TLPs to another platform 2 up to the TLP stored in the storage region on the memory 205 indicated by TLP_LIST_END included in the level table MlTbl of the priority Lvl_Mlow (No at Step S914), the PCIe controller 206a sets the address information of the storage region of a next TLP to transmit among the storage regions in the request table TLP MlList to TLP_LIST_CURRENT included in the level table MlTbl of the priority Lvl_Mlow (Step S915). The PCIe controller 206a also updates, to zero, the transfer completed bit of the address information stored in the storage region of the TLP having been lastly transmitted among the storage regions in the request table TLP MlList of the transaction having the priority Lvl_Mlow. Then, the PCIe controller 206a proceeds to Step S920.

At Step S914, after determining to have transmitted the TLPs to another platform 2 up to the TLP stored in the storage region on the memory 205 indicated by TLP_LIST_END included in the level table MlTbl of the priority Lvl_Mlow (Yes at Step S914), the PCIe controller 206a sets the end flag to the request table TLP MlList of the transaction having the priority Lvl_Mlow, completing the transmission of the transmit data of the transaction. Then, the PCIe controller 206a proceeds to Step S920.

At Step S912, if the address information is not set to TLP_LIST_CURRENT in the level table MlTbl of the priority Lvl_Mlow (No at Step S912), the PCIe controller 206a determines whether the address information is set to TLP_LIST_CURRENT in the level table LwTbl of the priority Lvl_Low (Step S916).

If the address information is not set to TLP_LIST_CURRENT in the level table LwTbl of the priority Lvl_Low (No at Step S916), the PCIe controller 206a proceeds to Step S920. If the address information is set to TLP_LIST_CURRENT in the level table LwTbl of the priority Lvl_Low (Yes at Step S916), the PCIe controller 206a transmits, to another platform 2, the TLPs in order starting from the TLP stored in the storage region on the memory 205 indicated by TLP_LIST_TOP included in the level table LwTbl of the priority Lvl_Low up to the TLP stored in the storage region on the memory 205 indicated by TLP_LIST_END included in the level table LwTbl, while shifting the storage regions one by one (Step S917). Upon every completion of the transmission of one TLP to another platform 2, the PCIe controller 206a determines whether to have transmitted the TLPs to another platform 2 up to the TLP stored in the storage region on the memory 205 indicated by TLP_LIST_END included in the level table LwTbl of the priority Lvl_Low (Step S918).

After determining to have not transmitted the TLPs to another platform 2 up to the TLP stored in the storage region on the memory 205 indicated by TLP_LIST_END included in the level table LwTbl of the priority Lvl_Low (No at Step S918), the PCIe controller 206a sets the address information of the storage region of a next TLP to transmit among the storage regions included in the request table TLP_LwList to TLP_LIST_CURRENT included in the level table LwTbl of the priority Lvl_Low (Step S919). The PCIe controller 206a also updates, to zero, the transfer completed bit of the address of the TLP having been lastly transmitted among the address information in the request table TLP_LwList of the transaction having the priority Lvl_Low. Then, the PCIe controller 206a proceeds to Step S920.

At Step S918, after determining to have transmitted the TLPs to another platform 2 up to the TLP stored in the storage region on the memory 205 indicated by TLP_LIST_END included in the level table LwTbl of the priority Lvl_Low (Yes at Step S918), the PCIe controller 206a proceeds to Step S920.

As described above, the information processing system 1 of the present embodiment can interrupt communication as transmission of the first transmit data of the first transaction, to transmit the second transmit data of the second transaction having a higher priority. As a result, without waiting for completion of the first transaction, the information processing system 1 can execute the second transaction having a higher priority such as progress check of the first transaction, interruption of the first transaction, and a power-on and off operation to the information processing system 1.

The information processing system 1 according to the present embodiment can determine whether error is occurring in transmission of the transmit data by checking the level tables. This makes it possible to reduce a processing load on the PCIe controller 206a to interrupt communication as transmission of the first transmit data of the first transaction, for preferentially transmitting the second transmit data of the second transaction having a higher priority.

The information processing system 1 according to the present embodiment can identify completion or non-completion of transmission of the TLPs to another platform 2, and thus can avoid transmitting the transmitted TLPs to another platform 2 again.

The information processing system 1 according to the present embodiment can easily determine occurrence or non-occurrence of error in the transmission of the transmit data by referring to the level tables.

### Second Embodiment

The first embodiment has described the outline of the transmission processing performed by the information processing system 1. A second embodiment specifically describes the transmission processing performed by the information processing system 1.

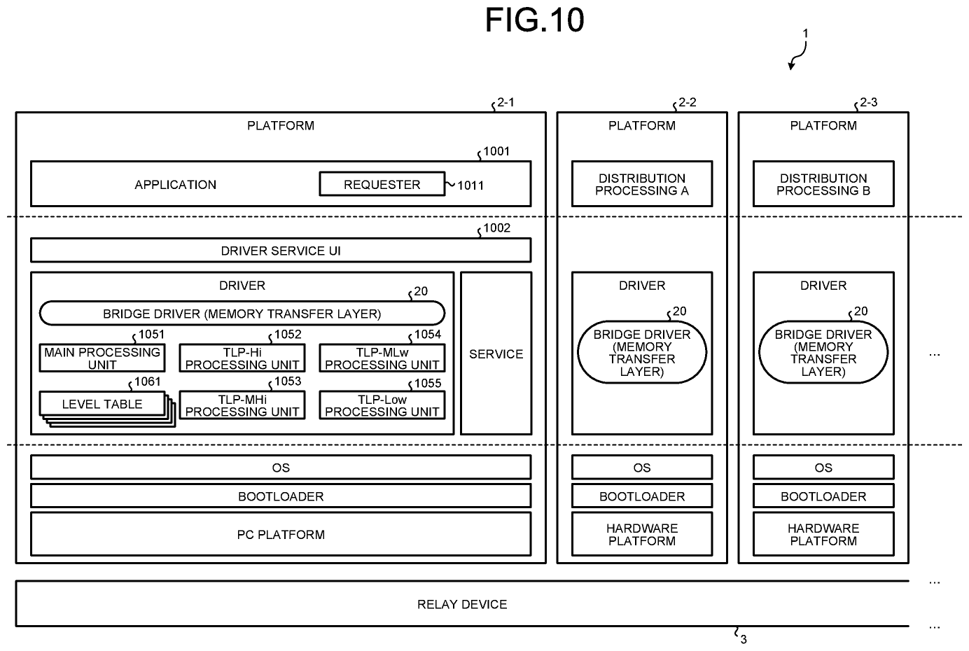

FIG. 10 is a diagram illustrating an exemplary detailed block configuration of software of the platforms 2-1 to 2-3 according to the present embodiment. As illustrated in FIG. 10, the platform 2-1 includes an application 1001. The application 1001 is software executed on the OS, and includes a requester 1011. The requester 1011 includes a request function to generate and transmit a request command to a driver via a driver service UI 1002 as described later.

The platform 2-1 further includes the driver service UI 1002, the driver, and a service. The driver service UI 1002 functions as an interface for invoking the driver from the application 1001. The driver and the service are software located below the driver service UI 1002. The driver includes the bridge driver 20, a main processing unit 1051, a TLP-Hi processing unit 1052, a TLP-MHi processing unit 1053, a TLP-MLw processing unit 1054, and a TLP-Low processing unit 1055. The driver further includes a plurality of level tables 1061.

The level tables 1061 are a group of tables for use in managing TLPs being divisions of a request command in accordance with the priority, and include the level tables HiTbl, MhTbl, MlwTbl, and LwTbl, for example.

The main processing unit 1051 performs overall control over reception of a request command from the requester 1011 and transmission of TLPs being divisions of the received request command.

The TLP-Hi processing unit 1052 transmits, to another platform 2, the TLP registered in the level table HiTbl of the priority Lvl_Hi being the highest priority.

The TLP-MHi processing unit 1053 transmits, to another platform 2, the TLP registered in the level table MHiTbl of the priority Lvl_MHi being the second highest priority after the priority Lvl_Hi.

The TLP-MLw processing unit 1054 transmits, to another platform 2, the TLP registered in the level table MLwTbl of the priority Lvl_MLw being the third highest priority after the priority Lvl_MHi.

The TLP-Low processing unit 1055 transmits, to another platform 2, the TLP registered in the level table LowTbl of the priority Lvl_Low being the lowest priority.

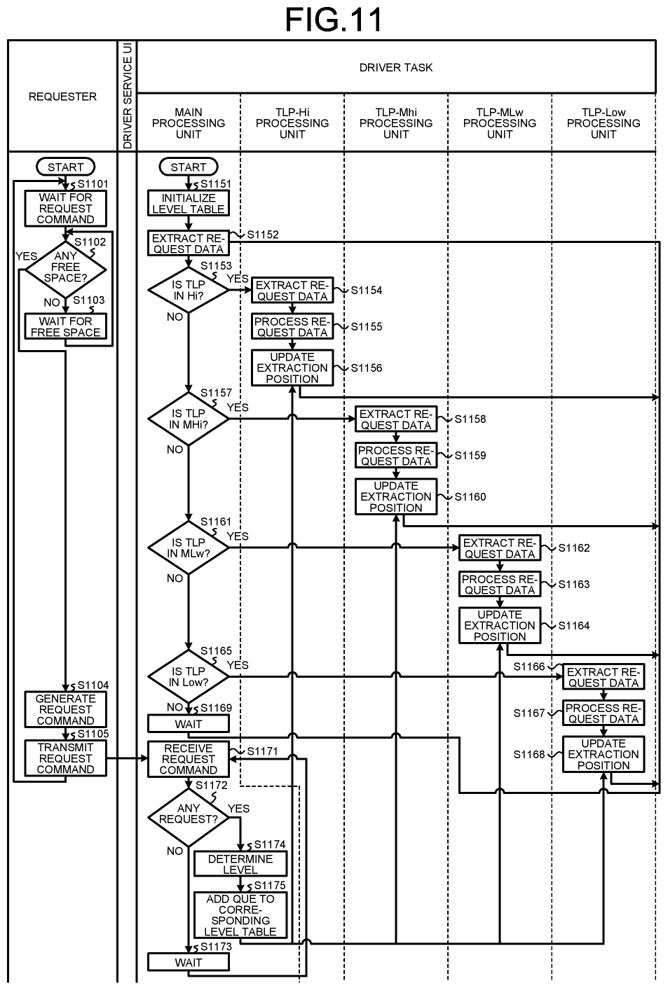

FIG. 11 is a sequence diagram illustrating a procedure performed by the elements of the information processing system 1 to transmit the transmit data in the second embodiment.

The requester 1011 waits for a request command (S1101). The request command may be, for example, a data transmission request for another platform 2.

After receiving a request command, the requester 1011 determines whether there is a free space for receiving the request command in a queue of a transmission destination of the request command (for example, another platform 2 connected via the PCIe) (S1102). After determining that there is no free space (No at S1102), the requester 1011 performs waiting control over the request command to wait for a free space (S1103), and performs the processing from S1102 again. In the present embodiment, the requester 1011 checks whether the queue has a free space before transmission of a request command, therefore, the requester 1011 can normally transmit the request command unless a communication failure occurs. A communication failure can be recognized from an error or a timeout.

After determining that there is a free space (Yes at S1102), the requester 1011 generates a request command (S1104). The requester 1011 transmits the request command to the main processing unit 1051 of the driver via the driver service UI 1002 (S1105).

After transmitting the request command, the requester 1011 performs the processing from S1101 again. Thereby, the requester 1011 can deal with a next request.

As illustrated in FIG. 11, the requester 1011 and the processing units of the driver process the request command in an asynchronous manner. The following describes processing performed by the processing units of the driver.

The main processing unit 1051 initializes the level tables 1061 (S1151). Examples of the level tables to be initialized include the level tables HiTbl, MhTbl, MlwTbl, and LwTbl.

At the time of receiving a request command from the requester 1011, the queue of TLPs corresponding to the request command are added to the level tables, which will be described later. In the present embodiment, the request command is divided in units of TLP data size for the purpose of physical transfer. Data obtained by dividing the request command by TLP data size is referred to as request data. That is, the request data is extracted in units of TLP to transmit.

The main processing unit 1051 starts extracting request data (S1152).

The main processing unit 1051 determines whether the level table HiTbl includes a requested TLP (S1153). The main processing unit 1051 makes this determination depending on whether the address information is set to TLP_LIST_CURRENT in the level table HiTbl. The main processing unit 1051 makes this determination about the other level tables in the same manner, therefore, a description thereof will be omitted.

After the main processing unit 1051 determines that the level table HiTbl includes the TLP (Yes at S1153), the TLP-Hi processing unit 1052 extracts request data corresponding to the TLP from the level table HiTbl (S1154).

The TLP-Hi processing unit 1052 transmits the extracted request data to another platform 2 (S1155).

With occurrence of error in the transmission, the main processing unit 1051 notifies the requester 1011 of a failure of transmission of the entire TLPs.

The TLP-Hi processing unit 1052 updates an extraction position to extract a next TLP (S1156). The TLP-Hi processing unit 1052 updates the extraction position by shifting the storage regions one by one upon every extraction of transmit data. The TLP-Hi processing unit 1052 continues to update the extraction position until the TLP is extracted from the storage region indicated by TLP_LIST_END in the level table HiTbl. The TLP-Hi processing unit 1052 updates the extraction position with respect to another level tables in the same manner, therefore, a description thereof will be omitted. Then, the main processing unit 1051 performs the processing from S1152 again. That is, the respective processing units of the driver according to the present embodiment promptly proceed to the next processing after completion of the transmission of the TLP, irrespective of occurrence or non-occurrence of error.

At S1153, after determining that the level table HiTbl includes no TLP (No at S1153), the main processing unit 1051 determines whether the level table MHiTbl includes the requested TLP (S1157).

After the main processing unit 1051 determines that the level table MHiTbl includes the TLP in question (Yes at S1157), the TLP-MHi processing unit 1053 extracts the request data corresponding to the TLP from the level table MHiTbl (S1158).

The TLP-MHi processing unit 1053 transmits the extracted request data to another platform 2 (S1159). The TLP-MHi processing unit 1053 updates the extraction position to extract a next TLP (S1160). Then, the main processing unit 1051 performs the processing from S1152 again.

At S1157, after determining that the level table MHiTbl includes no TLP (No at S1157), the main processing unit 1051 determines whether the level table MLwTbl includes the requested TLP (S1161).

After the main processing unit 1051 determines that the level table MLwTbl includes the TLP in question (Yes at S1161), the TLP-MLw processing unit 1054 extracts the request data corresponding to the TLP from the level table MLwTbl (S1162).

The TLP-MLw processing unit 1054 transmits the extracted request data to another platform 2 (S1163). The TLP-MLw processing unit 1054 updates the extraction position to extract a next TLP (S1164). Then, the main processing unit 1051 performs the processing from S1152 again.

At S1161, after determining that the level table MLwTbl includes no TLP (No at S1161), the main processing unit 1051 determines whether the level table LowTbl includes the requested TLP (S1165).

After the main processing unit 1051 determines that the level table LowTbl includes the TLP in question (Yes at S1165), the TLP-Low processing unit 1055 extracts the request data corresponding to the TLP from the level table LowTbl (S1166).

The TLP-Low processing unit 1055 transmits the extracted request data to another platform 2 (S1167). The TLP-Low processing unit 1055 updates the extraction position to extract a next TLP (S1168). Then, the main processing unit 1051 performs the processing from S1152 again.

At S1165, after determining that the level table LowTbl includes no TLP (No at S1165), the main processing unit 1051 waits for a given time (S1169), and performs the processing from S1152 again.

The main processing unit 1051 performs another processing asynchronous to the processing as above. This processing will be described below.

The main processing unit 1051 starts reception control over a request command from the requester 1011 (S1171). The main processing unit 1051 determines receipt or non-receipt of a request command (S1172). After determining receipt of no request command (No at S1172), the main processing unit 1051 waits for a given time (S1173), and performs the processing from S1171 again.

After determining receipt of a request command (Yes at S1172), the main processing unit 1051 determines priority (the level table to register) from a thread about the received request command or a command argument (S1174).

The main processing unit 1051 divides the request command in units of TLP data size and adds the divided commands as the transmit data to the queue of the determined level table (S1175). Then, the main processing unit 1051 updates information about the extraction position in the level table containing the added transmit data, to enable extraction of the transmit data. For example, the main processing unit 1051 updates TLP_LIST_END in accordance with the added transmit data.

In the present embodiment as described above, the main processing unit 1051 specifies a TLP to transmit in accordance with the priority, upon every transmission of a single TLP. Thereby, in response to receipt of a request command having a higher priority, the main processing unit 1051 can promptly implement transmission of the TLPs being the divided request commands with a higher priority during transmission of the TLPs corresponding to another request command.

### Third Embodiment

The first and second embodiments are not intended to limit the hardware configuration of the information processing system 1. The third embodiment describes another aspect of the hardware configuration of the information processing system.

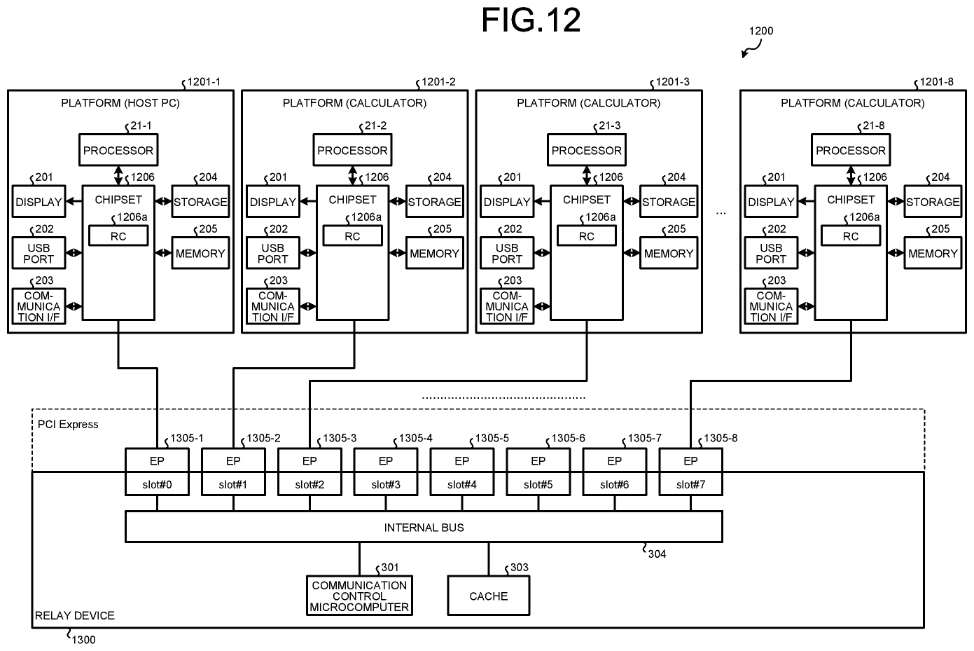

With reference to FIG. 12, an exemplary hardware configuration of an information processing system 1200 of a third embodiment is now described. The same or like elements as in FIG. 2 are denoted by the same reference numerals, and a description thereof is omitted.

FIG. 12 is a diagram illustrating an exemplary hardware configuration of the information processing system 1200 of the third embodiment. The following describes an example that a platform 1201-1 functions as a host PC and platforms 1201-2, to 1208-8 function as calculators to execute AI inference processing or image processing, for example.

Of the hardware configuration of the platform 1201-1 serving as the host PC, the elements except for a chipset 1206 are the same as those of the platform 2-1 in FIG. 2, and a description thereof is thus omitted. Likewise, the platforms 1201-2 to 1208-8 serving as calculators to execute AI inference processing or image processing have the same hardware configuration as the platforms 2-2 to 2-8 in FIG. 2 except for the chipset 1206, and a description thereof is thus omitted.

Each chipset 206 is connected to the processor 21-1, the USB port 202, the communication I/F 203, the storage 204, and the memory 205. In the third embodiment the chipset 206 includes a root complex (RC) 1206a to be connected to a relay device 1300.

Next, a hardware configuration of the relay device 1300 is described.

As illustrated in FIG. 12, the relay device 1300 includes a communication control microcomputer 301, a power control microcomputer 302, a cache 303, and a plurality of end points (EP) 1305-1 to 1305-8. The end points (EP) 1305-1 to 1305-8 function as expansion slots or expansion bus to be connected to devices that satisfy PCIe protocol. The end points 1305-1 to 1305-8 serve to connect to the platforms 1201-1 to 1201-8, and are assigned with slot numbers (slot #0 to slot #7).

In the relay device 1300, the communication control microcomputer 301, the cache 303, and the end points 1305-1 to 1305-8 are connected to one another in a communicable manner via an internal bus 304.

While one platform 1201 may be connected to one end point 1305, two or more platforms 1201 may be connected to one end point 1305. Further, one platform 1201 having two or more end points 1305 allocated can perform communication in a broader communication band.

The relay device 1300 transfers data to two or more root complexes (RC) 1206a by tunneling data from end point to end point (EP to EP).

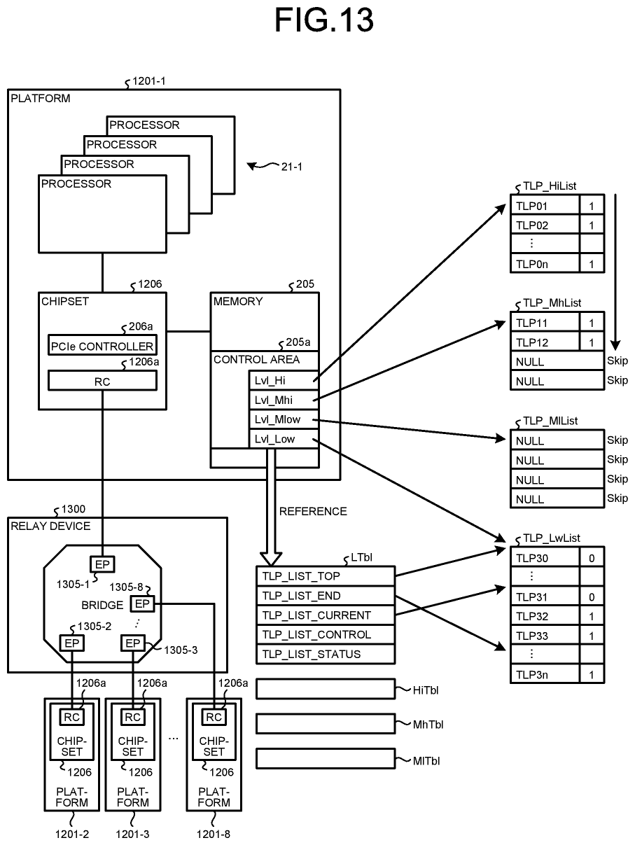

Next, with reference to FIG. 13, the following describes an exemplary procedure of transmitting transmit data by the platform 1201-1 in the information processing system 1200 according to the third embodiment. Writing transmit data to a request table (for example, a request table TLP_LwList) and setting of a level table (for example, a level table LwTbl of priority Lvl_Low) are the same as those in FIG. 8, and a description thereof is thus omitted.

The PCIe controller 206a reads TLPs in order starting from a TLP (for example, TLP30) stored in the storage region on the memory 205 indicated by TLP_LIST_TOP included in the level table LwTbl having the priority Lvl_Low up to a TLP (TLP3n) stored in the storage region on the memory 205 indicated by TLP_LIST_END included in the level table LwTbl, while shifting the storage regions one by one. The root complex 1206a transmits the read TLPs (TLP3n) to the corresponding end point 1305 and tunnels the data from end point to end point (EP to EP). The end point 1305-2 then transfers the TLPs (TLP3n) to the root complex 1206a of another platform 2.

Upon every transmission of one TLP of the transmit data of a transaction having the priority Lvl_Low, the PCIe controller 206a determines whether to have received a transmission/reception request for the transmit data of transactions having the priorities Lvl_Hi, Lvl_Mhi, and Lvl_Mlow higher than the priority Lvl_Low.

In response to receipt of a transmission/reception request for the transmit data of transactions having the priorities Lvl_Hi and Lvl_Mhi during transmission of a TLP (for example, TLP 31) of the transmit data of the transaction having the priority Lvl_Low, the PCIe controller 206a writes the transmit data into the request tables TLP HiList and TLP_MhList of the transactions having the priorities Lvl_Hi and Lvl_Mhi. Referring to the request tables TLP HiList and TLP_MhList, the PCIe controller 206a also sets the level tables HiTbl and MhTbl of the priorities Lvl_Hi and Lvl_Mhi.

Subsequently, the PCIe controller 206a interrupts the transmission of the TLP of the transmit data of the transaction having the priority Lvl_Low, and reads TLPs in order starting from a TLP (for example, TLP01) stored in the storage region on the memory 205 indicated by TLP_LIST_TOP included in the level table HiTbl of the priority Lvl_Hi up to a TLP (for example, TLP0n) stored in the storage region on the memory 205 indicated by TLP_LIST_END included in the level table HiTbl, while shifting the storage regions one by one. The root complex 1206a transmits the read TLPs to the end point 1305-1 of the relay device 1300. Thereby, the PCIe controller 206a performs the same processing as described above, to transfer the TLPs to another platform 2.

Processing involving in the level tables with the other priorities is the same as that in FIG. 8 of the first embodiment except for the relay device 1300's data tunneling from end point to end point (EP to EP), and a description thereof is thus omitted.

The third embodiment has described the example that the platform 1201 includes the root complex 1206a and the relay device 1300 includes the end points 1305. However, the third embodiment is not intended to limit the arrangement and connections of the root complex and the end points. Other arrangement and connections may be applied.

The first to third embodiments have described the PCIe as an I/O serial interface for the respective elements by way of example. The I/O serial interface is not limited to the PCIe. The I/O serial interface for the respective elements may be optionally adopted as long as it can implement data transfer between a device as a peripheral controller and a processor via a data transfer bus. The data transfer bus may be a general-purpose bus that can transfer data at high speed in a local environment such as one system or device inside a housing.

The I/O serial interface may be configured to be point-to-point connectable and transfer data in serial on a packet basis. The I/O serial interface may include a plurality of lanes. The layer structure of the I/O serial interface may include a transaction layer that generates and decodes packets, a data link layer for error detection, and a physical layer for serial and parallel conversion. The I/O serial interface may also include a root complex with one or more ports at the top hierarchy, an end point serving as an I/O device, a switch for increasing the number of ports, and a bridge for converting a protocol, for example. The I/O serial interface may multiplex and transmit a clock signal and data by a multiplexer. In this case, the reception side may include a demultiplexer to demultiplex the data and the clock signal.

According to one aspect of this disclosure, the controller can interrupt transmission of first transmit data of a first transaction to execute transmission of transmit data of a second transaction with a higher priority. That is, the controller can execute the second transaction such as transaction progress check, interruption of a transaction, and a power-on/off operation to the information processing system, without waiting for completion of the first transaction.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
a plurality of platforms; and
a relay device comprising an expansion bus that connects between the platforms, wherein
the platforms each comprise:
a memory that stores transmit data to be transmitted to another platform through transactions occurring in the platform concerned; and
a controller that:
reads, from the memory, first transmit data to be transmitted to the another platform, and transmits the first transmit data to the another platform through a first transaction among the transactions via the expansion bus,
determines whether a second transaction is occurring in the platform after completion of transmission of each of packets included in the first transmit data, the second transaction being higher in priority than the first transaction, and
in response to occurrence of the second transaction, reads, from the memory, second transmit data to be transmitted to the another platform, transmits the second transmit data to the another platform through the second transaction via the expansion bus, and interrupts transmission of the first transmit data until completion of transmission of the second transmit data.

2. The information processing system according to claim 1, wherein
the memory stores, for priority of each of the transactions, a level table containing current information, the current information representing address information of a storage region of a next packet to transmit on the memory, among the packets included in the transmit data to be transmitted to the another platform in each transaction having the priority, and
after completion of transmission of the second transmit data, the controller resumes transmission of the packets included in the first transmit data from a packet stored in the storage region indicated by the current information contained in the level table for the priority of the first transaction.

3. The information processing system according to claim 1, wherein
the memory stores the address information of the storage region of each of the packets on the memory,
the address information includes transfer completion information representing completion or non-completion of transmission of each of the packets, and
the controller transmits, to the another platform, the packet whose transfer completion information indicates non-completion of transmission, among the packets included in the first transmit data.

4. The information processing system according to claim 2, wherein
the level table further contains status information representing occurrence or non-occurrence of error in the transmission of the transmit data.
